(19) United States
(12) Patent Application Publication
(10) Pub. No.: US 2014/0335006 A1
(43) Pub. Date: Nov. 13, 2014

(54) METHOD FOR PRODUCING TETRAHALOSILANES

(71) Applicant: Spawnt Private S.à.r.l., Luxembourg (LU)

(72) Inventor: Norbert Auner, Glashuetten (DE)

(73) Assignee: Spawnt Private S.à.r.l., Luxembourg (LU)

(21) Appl. No.: 14/353,910

(22) PCT Filed: Oct. 26, 2012
(86) PCT No.: PCT/EP2012/071290

§ 371 Date: Apr. 24, 2014

(30) Foreign Application Priority Data
Oct. 27, 2011 (DE) 102011117111.1

(51) Int. Cl. C01B 33/107

(52) U.S. Cl. CPC C01B 33/10747; C01B 33/10705
USPC 423/341

(57) ABSTRACT

A method produces tetrahalosilanes (SiX₄) (X=halogen, more particularly Cl, F) from processed rock masses including high-viscosity hydrocarbons and SiO₂ and/or silicates, or from the residue masses obtained in the course of such processing. The masses may be heated in a stream of hydrogen halide, and the (SiX₄) which forms in the course of this heating is captured or distilled off. The masses may be admixed with hydrofluoric acid (HF) and/or alkali metal fluoride or alkaline earth metal fluoride and with sulfuric acid, and the (SiX₄) which forms in the course of the admixing is captured or distilled off.

### TECHNICAL FIELD

This disclosure relates to a method of producing tetrahalosilanes (SiX₄) (X=halogen, more particularly Cl, F).

### BACKGROUND

Tetrahalosilane constitutes an important starting material for the manufacture of silicon. However, there is a need to provide a method of producing tetrahalosilanes that is particularly highly efficient.

### SUMMARY

I provide a method of producing tetrahalosilanes (SiX₄) wherein X=halogen from processed rock masses including high-viscosity hydrocarbons and SiO₂ and/or silicates, or from residue masses obtained in such processing including heating the masses in a stream of hydrogen halide and capturing or distilling off formed SiX₄.

I also provide a method of producing tetrahalosilanes (SiX₄) wherein X=halogen from processed rock masses including high-viscosity hydrocarbons and SiO₂ and/or silicates, or from residue masses obtained in such processing, including admixing the masses with hydrofluoric acid (HF) and/or alkali metal fluoride or alkaline earth metal fluoride and with sulfuric acid and capturing or distilling off formed SiX₄.

### DETAILED DESCRIPTION

I provide a method of producing tetrahalosilanes (SiX₄) (X=halogen, more particularly Cl, F) from processed rock masses comprising high-viscosity hydrocarbons and SiO₂ and/or silicates, or from the residue masses obtained in such processing, wherein the masses are heated in a stream of hydrogen halide and the SiX₄ formed during this process is captured or distilled off.

I exploit the fact that such processed rock masses or residues still contain carbon in the form of high-viscosity hydrocarbons. This carbon is used to reduce the SiO₂ present in the rock masses, and/or the corresponding silicates. Hence, a reducing agent already present in the starting material is employed specifically for preparation of tetrahalosilanes, and can then be converted in further reaction steps to the desired Si. It is important that the starting materials in question here (rock masses, residue masses) contain carbons to a sufficient extent to allow the desired reduction of SiO₂ or silicates to be implemented. These masses contain, for example, high-viscosity hydrocarbons in the form of bitumen or tar. The C content of the masses is preferably identified to determine whether there is a sufficient amount of carbon. If this content is not sufficient, carbon is added to the masses before or during heating. In this eventuality, cheap carbon (bituminous coal, dried biomass, oil carbon and the like) is preferably employed.

The masses may be heated to about 400-500° C. for removal of residual water and, thereafter, to about 1000-1300° C. for the recovery of SiX₄.

Examples of such rock masses are oil sands or oil shales. The term “rock mass” is intended to cover oil muds as well, although in that case no rock is involved. For example, low-viscosity hydrocarbons (mineral oil) are obtained from these rock masses by methods that are nowadays customary after which the residues, which preferably comprise SiO₂-containing material and ultrahigh-viscosity hydrocarbon residues (bitumen residues), are employed as starting materials for the method. In particular, there is a residue analysis to determine the C content, the addition, optionally, of carbon, and the two-stage heating operation (400-500° C. for removal of residual water, 1000-1300° C. for reduction). Heating to 1000-1300° C. takes place in a stream of hydrogen halide, with SiX₄ being captured in a cold trap or distilled off. The energy in this case may be supplied conventionally or alternatively by alternating electromagnetic fields (microwave, for example).

Alternatively, I provide a method of producing tetrahalosilanes (SiX₄) (X=halogen, more particularly Cl, F) from processed rock masses comprising high-viscosity hydrocarbons and SiO₂ and/or silicates, or from the residue masses obtained in the course of such processing, wherein the masses are admixed with hydrofluoric acid (HF) and/or alkali metal fluoride or alkaline earth metal fluoride and with sulfuric acid, and the SiX₄ formed in the course of such admixing is captured or distilled off.

With this method, conversion of the starting substances takes place with hydrofluoric acid or with corresponding fluorides. In this case, the carbon present in the starting substances is used as a suitable energy source for the further processing of the recovered SiX₄ to Si. Hence, there is an effective and efficient utilization of the materials present in the starting substances. SiF₄ is obtained in situ with this method.

As already mentioned, the SiX₄ recovered can be further processed to Si in a known way. For example, SiX₄ can be converted into polyhalosilanes via plasma chemistry methods. Thermolysis at about 800-1000° C. then gives Si and also SiX₄, which can be then recycled.

The residue comprises alkali/alkaline earth metal oxides and/or halides, which are easily separable from SiX₄.

The processed rock masses or residue masses are preferably obtained by removal of the mineral oil present in the rock, more particularly by way of conventional extraction and recovery processes such as SAGD (steam assisted gravity drainage), CSS (cyclic steam stimulation), THAI (toe to heel air injection), VAPEX (vapor extraction process).

It is assumed that processed rock masses or residue masses are masses from which valuable low-viscosity hydrocarbons (mineral oil) have already been removed by appropriate processing and/or recovery processes. All that remain in the rock masses or residues, therefore, are hydrocarbons of relatively high viscosity, which are used for the reduction procedure or as energy source for the further processing of SiX₄ to Si. The method, however, does not rule out the use, for the method, of masses from which no low-viscosity hydrocarbons have been previously removed. Such masses may be, for example, rock masses having a relatively low fraction of low-viscosity hydrocarbons so that recovery thereof is unprofitable, or in which the low-viscosity hydrocarbons present have been converted into higher-viscosity hydrocarbons, by carbonization, for example.

Accordingly, the processed rock masses or the residue masses may be obtained by heating ground starting substances at atmospheric pressure and, optionally, distillatively removing low-viscosity hydrocarbons. Rising temperatures here lead to additional carbonization as a result of thermolysis-pyrolysis (T from RT to about 800° C.), which significantly increases the C fraction.

In principle, it is the case that the low-viscosity hydrocarbons (mineral oil) recovered can be supplied to an external use or alternatively can be used as an energy source for the heating of the masses.

The processed rock masses or residue masses may be obtained by gentle heating under reduced pressure and by grinding of the starting substances and by optional distillative removal of low-viscosity hydrocarbons. It is possible here to operate, for example, with a reduced pressure of down to 10⁻³ mbar. This method has the advantage that a high proportion of the hydrocarbons can be removed by distillation, leaving only small amounts of bitumen.

The processed rock masses or residue masses may also be obtained by carbonization of starting substances in an enclosed space. In this case, substantially all low-viscosity hydrocarbons and mineral oil constituents undergo pyrolysis. Hence, the entire carbon present can be amenable to exploitation by the method.

As a result of the above-described methods (pyrolysis, carbonization), therefore, it is possible to control (enrich) the C fraction in the masses. Preferably, however, as much mineral oil as possible is recovered from the masses so that only the residue fraction of hydrocarbons is used for the method.

My methods are illustrated in detail below by working examples.

### Example 1

9.2 g of finely ground oil sand (4 g content of pure SiO₂), whose C content according to residue analysis was 0.037 g (=8%) based on oil sand and 18.4% based on SiO₂, were admixed with 8.0 g of powdered activated carbon and 6 g of dextran, pasted up with a little water, pelletized, and dried in a drying cabinet at 100° C. The pellets were packed tightly in a quartz tube (internal diameter 22 mm) between two quartz wool plugs, and calcined in a tube furnace at 800° C. to remove residues of water and to pyrolyze the dextran. The temperature was subsequently raised to 1300° C. and a stream of HCl gas of 4 l/h was passed through the packing. In the course of the reaction, the pellets broke down into powdery material, necessitating a reduction in the quantity of HCl gas to 3 l/h after a reaction time of 4 hours. The reaction gases were passed through a cold trap (−70° C.) to separate resultant products from remaining HCl gas, H₂, CO, and CO₂. After a reaction time of 12 hours, only residues of silicatic material and alkali metal/alkaline earth metal oxides and chlorides were detectable in the powder bed. The isolated yield of SiCl₄ was 9.23 g (81.6% of the theoretical yield, based on SiO₂). Additionally, thereafter, 4.1 g of AlCl₃ were separated off by sublimation.

### Example 2

9.2 g of ground oil sand (residue C content: 8%, 18.4% based on 4 g of SiO₂) (average particle size 0.32 mm, corresponding to a theoretical specific surface area of 75 cm²/g), 8.2 g of powdered activated carbon, and 6 g of dextran were treated as in Example 1, and the reaction was carried out in the same way but at 1100° C. After a reaction time of 12 hours, the conversion of SiO₂-containing material was still not complete. The isolated yield of SiCl₄ was 4.52 g (40% of the theoretical overall conversion, based on SiO₂). In addition, AlCl₃ was isolated as well.

### Example 3

9.15 g of oil sand (corresponding to 4 g of SiO₂) with 8% or 18.4% C presence were admixed alternatively with 16 g of ammonium fluoride (NH₄F) or with 16 g of calcium difluoride (CaF₂), and 100 ml of concentrated sulfuric acid (H₂SO₄) were added slowly dropwise in each case. By slow heating of the mixture to about 170° C. (over 4 hours), 6.4 g or 5.3 g, respectively, of SiF₄ in gas form were given off, and were collected in a cold trap cooled to −196° C. (liquid N₂). Yield: 77% or 64% of theory, respectively. SiF₄ was characterized by ¹H and ¹⁹F NMR and by GC/MS analysis.

1. A method of producing tetrahalosilanes (SiX₄) wherein X=halogen from processed rock masses comprising high-viscosity hydrocarbons and SiO₂ and/or silicates, or from residue masses obtained in such processing, comprising heating the masses in a stream of hydrogen halide and capturing or distilling off formed SiX₄.

2. The method according to claim 1, further comprising identifying the C content of the masses.

3. The method according to claim 1, further comprising adding carbon to the masses before or during heating.

4. The method according to claim 1, wherein the masses are heated to about 400-500° C. for removal of residual water and, thereafter, to about 1000-1300° C. for recovery of SiX₄.

5. A method of producing tetrahalosilanes (SiX₄) wherein X=halogen from processed rock masses comprising high-viscosity hydrocarbons and SiO₂ and/or silicates, or from residue masses obtained in such processing, comprising admixing the masses with hydrofluoric acid (HF) and/or alkali metal fluoride or alkaline earth metal fluoride and with sulfuric acid and capturing or distilling off formed SiX₄.

6. The method according to claim 1, further comprising removing mineral oil present in rock via extraction and recovery processes, SAGD, CSS, THAI or VAPEX to obtain the processed rock masses or residue masses.

7. The method according to claim 1, wherein the processed rock masses or residue masses are obtained by the heating at atmospheric pressure of ground starting substances and, optionally, distillation of low-viscosity hydrocarbons.

8. The method according to claim 1, wherein the processed rock masses or residue masses are obtained by the gentle heating under reduced pressure of ground starting substances and, optionally, distillation of low-viscosity hydrocarbons.

9. The method according to claim 1, wherein the processed rock masses or residue masses are obtained by carbonization of starting substances in an enclosed space.

10. The method according to claim 1, wherein processed rock masses or residue masses are obtained during mineral oil production from oil shales, oil sands, or oil muds.

11. The method according to claim 2, further comprising adding carbon to the masses before or during heating.

12. The method according to claim 2, wherein the masses are heated to about 400-500° C. for removal of residual water and, thereafter, to about 1000-1300° C. for recovery of SiX₄.

13. The method according to claim 3, wherein the masses are heated to about 400-500° C. for removal of residual water and, thereafter, to about 1000-1300° C. for recovery of SiX4.

14. The method according to claim 5, further comprising removing mineral oil present in rock via extraction and recovery processes, SAGD, CSS, THAI or VAPEX to obtain the processed rock masses or residue masses.

15. The method according to claim 5, wherein the processed rock masses or residue masses are obtained by the heating at atmospheric pressure of ground starting substances and, optionally, distillation of low-viscosity hydrocarbons.

16. The method according to claim 5, wherein the processed rock masses or residue masses are obtained by the gentle heating under reduced pressure of ground starting substances and, optionally, distillation of low-viscosity hydrocarbons.

17. The method according to claim 5, wherein the processed rock masses or residue masses are obtained by carbonization of starting substances in an enclosed space.

18. The method according to claim 5, wherein processed rock masses or residue masses are obtained during mineral oil production from oil shales, oil sands, or oil muds.
